(19) United States
(12) Patent Application Publication
(10) Pub. No.: US 2012/0153889 A1
(43) Pub. Date: Jun. 21, 2012

(54) CHARGING CIRCUIT

(75) Inventors: LING-YU XIE, Shenzhen City, Guangdong Province (CN); XING-PING XIE, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/169,082

(22) Filed: Jun. 27, 2011

(30) Foreign Application Priority Data
Dec. 16, 2010 (CN) 201010591549.4

(51) Int. Cl. H02J 7/00

(52) U.S. Cl. 320/107

(57) ABSTRACT

A charging circuit includes a DC (Direct Current) power source, a rechargeable battery, and a switch circuit. The DC power source includes positive and negative output terminals, and the switch circuit is connected to and located between the DC power source and the rechargeable battery. The switch circuit comprises an arrangement of transistors and other components which permits the connection of the battery in any manner, and the normal charging or recharging of the battery notwithstanding the polarity of the battery terminals.

### BACKGROUND

1. Technical Field

The present disclosure relates to a charging circuit capable of safely charging a rechargeable battery.

2. Description of Related Art

A typical charging circuit includes a power charger and a rechargeable battery. The power charger includes an alternative current (AC) power plug and a direct current (DC) output port having positive and negative terminals. The AC power plug is used to electrically connect to an AC power source for receiving the AC power.

The power charger can convert the AC power to DC power which is output from the output port to the chargeable battery. The positive terminal of the rechargeable battery is connected to the positive terminal of the power charger. The negative terminal of the rechargeable battery is connected to the negative terminal of the power charger. Then the chargeable battery can be charged by the power charger. However, if the positive and negative terminals of the rechargeable battery are incorrectly connected, the power charger can not charge the rechargeable battery and may even damage the rechargeable battery.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a charging circuit according to an embodiment.

FIG. 2 is a detailed circuit of the charging circuit of FIG. 1, showing a rechargeable battery connected to a DC power source in a first manner.

FIG. 3 is similar to FIG. 2, but showing the rechargeable battery connected to the power charger in a second manner.

FIG. 4 is a block diagram of a power charger according to an embodiment.

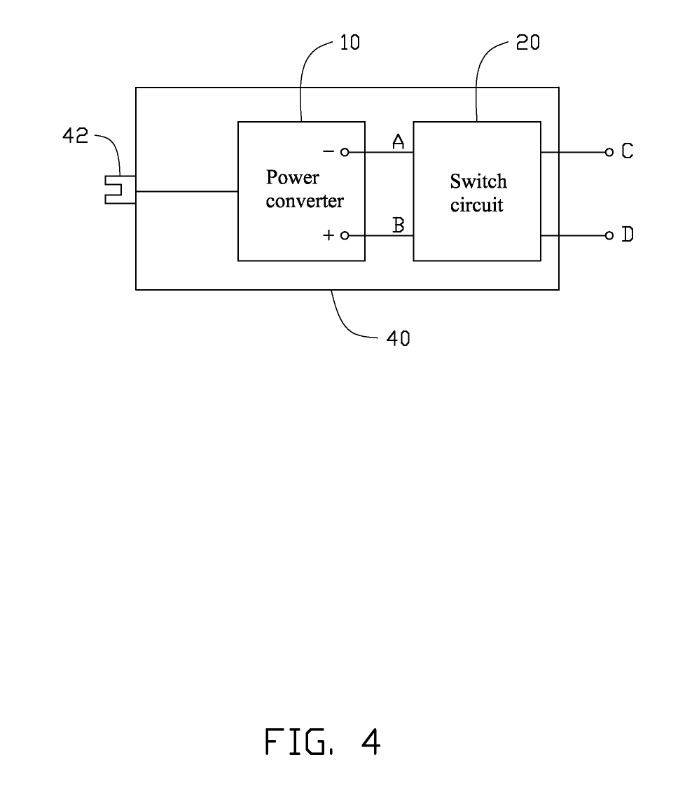

### DETAILED DESCRIPTION

The disclosure is illustrated by way of example and not by way of limitation. In the figures of the accompanying drawings in which like references indicate similar elements. It should be noted that references to “an” or “one” embodiment in this disclosure are not necessarily to the same embodiment, and such references mean at least one.

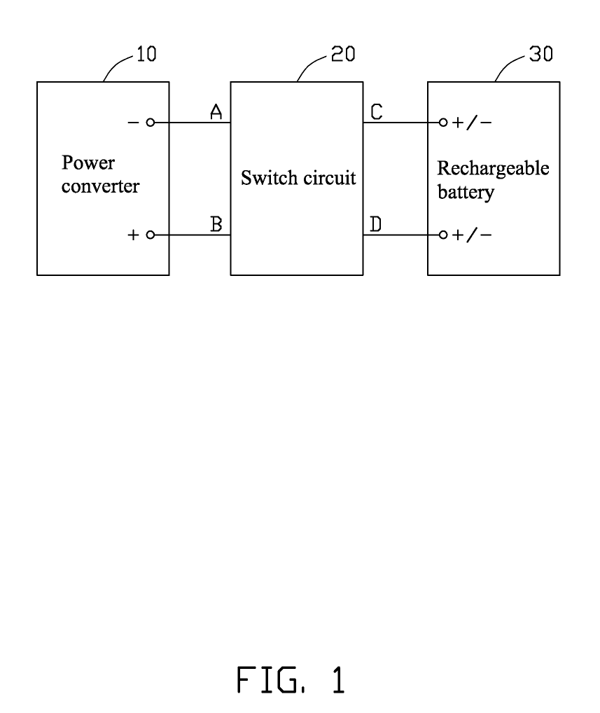

Referring to FIG. 1, an embodiment of a charging circuit includes a power converter 10 and a switch circuit 20 connected to the power converter 10. The charging circuit can recharge a rechargeable battery 30. The power converter 10 comprises a positive output terminal and a negative output terminal. The switch circuit 20 comprises a first input terminal A connected to the negative output terminal and a second input terminal B connected to the positive output terminal. The switch circuit 20 comprises a first output terminal C and a second output terminal D. The rechargeable battery 30 comprises a positive input terminal and a negative input terminal. The first output terminal C is connected to one of the positive and negative input terminals. The second output terminal D is connected to the other one of the positive and negative input terminals. In one embodiment, the power converter 10 connects to an AC power source and converts the AC power source to DC power source which is supplied to the rechargeable battery 30 via the positive and negative output terminals.

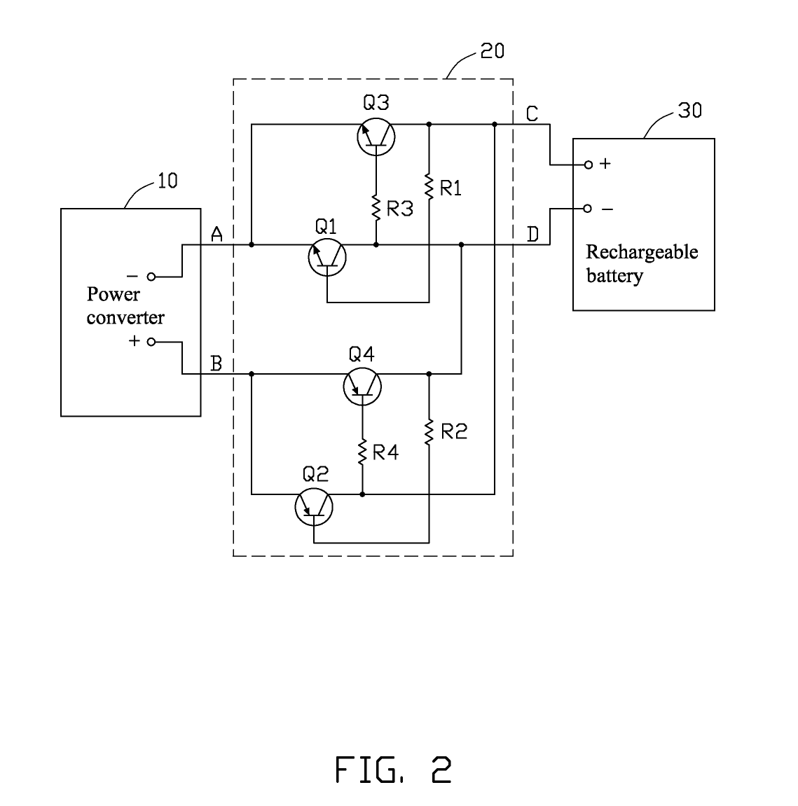

Referring to FIG. 2, the switch circuit 20 includes a first transistor Q1, a second transistor Q2, a third transistor Q3, a fourth transistor Q4, and resistors R1˜R4. The first transistor Q1 and the third transistor Q3 are both NPN type bipolar transistors. The second transistor Q2 and the fourth transistor Q4 are both PNP type bipolar transistors. The first transistor Q1 comprises a first base terminal, a first collector terminal, and a first emitting terminal. The first base terminal is connected to the first output terminal C via the resistor R1. The first collector terminal is connected to the second output terminal D. The first emitter terminal is connected to the negative output terminal. The second transistor Q2 comprises a second base terminal, a second collector terminal, and a second emitting terminal. The second base terminal is connected to the second output terminal D via the resistor R2. The second collector terminal is connected to the first output terminal C. The second emitter terminal is connected to the positive output terminal. The third transistor Q3 comprises a third base terminal, a third collector terminal, and a third emitting terminal. The third base terminal is connected to the second output terminal D via the resistor R3. The third collector terminal is connected to the first output terminal C. The third emitter terminal is connected to the negative output terminal. The fourth transistor Q4 comprises a fourth base terminal, a fourth collector terminal, and a fourth emitting terminal. The fourth base terminal is connected to the first output terminal C via the resistor R4. The fourth collector terminal is connected to the second output terminal D. The fourth emitter terminal is connected to the positive output terminal.

When the rechargeable battery 30 are connected to the output terminals C and D in a first manner as shown in FIG. 2, the first base terminal is at a high level, thereby rendering the first transistor Q1 conductive. The second base terminal is at a low level, thereby rendering the second transistor Q2 conductive. The third base terminal is at a low level, thereby rendering the third transistor Q3 non-conductive. The fourth base terminal is at a high level, thereby rendering the fourth transistor Q4 non-conductive. The positive input terminal is connected to the positive output terminal via the conductive second transistor Q2. The negative input terminal is connected to the negative output terminal via the conductive first transistor Q1. Thus current from the positive output terminal can flow to the positive input terminal, and return to the negative output terminal via the negative input terminal. In such a manner, the rechargeable battery 30 can be recharged normally.

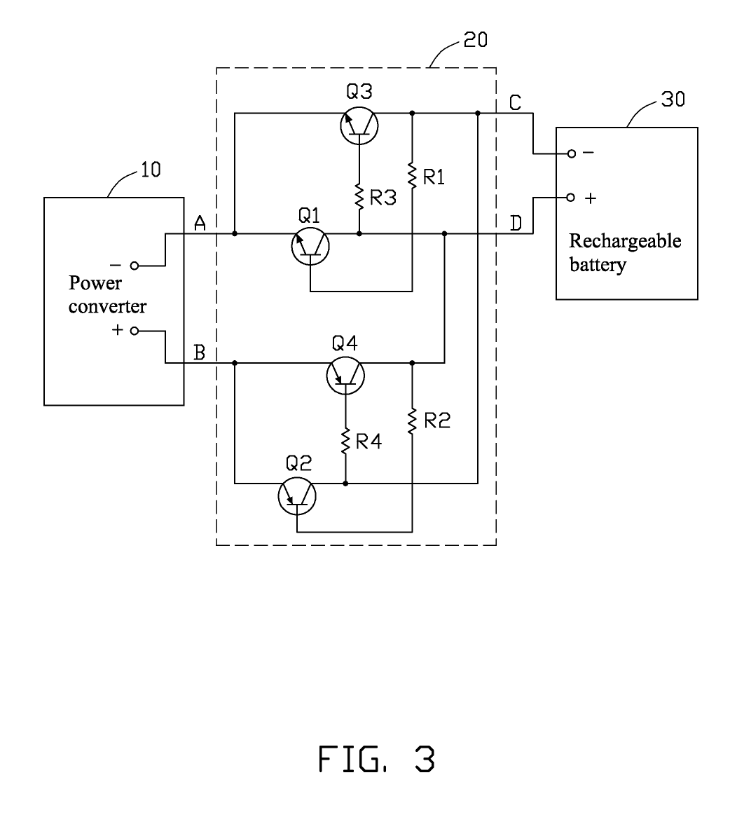

Referring to FIG. 3, when the rechargeable battery 30 are connected to the output terminals D and C in a second manner as shown in FIG. 3, the third base terminal is at a high level, thereby rendering the third transistor Q3 conductive. The fourth base terminal is at low level, thereby rendering the fourth transistor Q4 conductive. The first base terminal is at a low level, thereby rendering the first transistor Q1 non-conductive. The second base terminal is at high level, thereby rendering the second transistor Q2 non-conductive. The positive input terminal is connected to the positive output terminal via the conductive fourth transistor Q4. The negative input terminal is connected to the negative output terminal via the conductive third transistor Q3. The rechargeable battery 30 can also be normally recharged when the rechargeable battery 30 is connected to the power converter 10 in the second manner. Thus, the rechargeable battery 30 will be recharged notwithstanding a disorientation of the terminals of the battery 30.

In one embodiment, the first transistor Q1 and the second transistor Q2 belong to a first group of switches. The third transistor Q3 and the fourth transistor Q4 belong to a second group of switches. When the rechargeable battery 30 is connected to the DC power source 10 in the first manner, the first group of switches is switched on to connect the rechargeable battery 30 correctly to the power converter 10. When the rechargeable battery 30 is connected to the DC power source 10 in the second manner (the disoriented manner), the second group of switches switches on to connect the rechargeable battery 30 correctly to the power converter 10. Therefore, the rechargeable battery 30 can be charged safely in either manner.

In one embodiment, the power converter 10 and the switch circuit 20 are contained in a power charger 40. The power charger 40 includes an AC power plug 42 for receiving power from the AC power source. Such a power charger 40 can charge the rechargeable battery 30 normally notwithstanding the manner of connection of the terminals of the rechargeable battery 30 to the DC power source's output terminals.

While the present disclosure has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

What is claimed is:

1. A charging circuit for charging a rechargeable battery with a positive input terminal and a negative input terminal, the charging circuit comprising:
a power converter, having a positive output terminal and a negative output terminal, and adapted to convert alternative current (AC) power to direct current (DC) power;
a switch circuit comprising a first input terminal connected to the positive output terminal, a second input terminal connected to the negative output terminal, a first output terminal for connecting to one of the positive input terminal and the negative input terminal, and a second output terminal for connecting to the other one of the positive input terminal and the negative input terminal.

2. The charging circuit of claim 1, wherein the switch circuit comprises a first group of switches and a second group of switches, one of the first group of switches and the second group of switches is adapted to be switched on for connecting the rechargeable battery to the power converter.

3. The charging circuit of claim 2, wherein the first group of switches is adapted to be switched on when the positive input terminal is connected to the first output terminal and the negative input terminal is connected to the second output terminal; and the second group of switches is adapted to be switched on when the negative input terminal is connected to the first output terminal and the positive input terminal is connected to the second output terminal.

4. The charging circuit of claim 2, wherein the first group of switches comprises a first transistor and a second transistor, and the first transistor and the second transistor are connected to the power converter.

5. The charging circuit of claim 4, wherein the first transistor comprises a first base terminal, a first collector terminal, and a first emitting terminal; the second transistor comprises a second base terminal, a second collector terminal, and a second emitting terminal; the first base terminal is connected to the first output terminal, the first collector terminal is connected to the second output terminal, and the emitting terminal is connected to the negative output terminal; and the second base terminal is connected to the second output terminal, the second collector terminal transistor is connected to the first output terminal, and the second emitting terminal is connected to the positive output terminal.

6. The charging circuit of claim 5, wherein the first transistor is an NPN-type bipolar transistor, and the second transistor is a PNP-type bipolar transistor.

7. The charging circuit of claim 2, wherein the second group of switches comprises a third transistor and a fourth transistor, and the third transistor and the fourth transistor is connected to the power converter.

8. The charging circuit of claim 7, wherein the third transistor comprises a third base terminal, a third collector terminal, and a third emitting terminal; the fourth transistor comprises a fourth base terminal, a fourth collector terminal, and a fourth emitting terminal; the third base terminal is connected to the second output terminal, the third collector terminal is the first output terminal, and the third emitting terminal is connected to the negative output terminal; and the fourth base terminal is connected to the first output terminal, the fourth collector terminal is connected to the second output terminal, and the fourth emitting terminal is connected to the positive output terminal.

9. The charging circuit of claim 8, wherein the third transistor is an NPN-type bipolar transistor, and the fourth transistor is a PNP-type bipolar transistor.

10. A charging circuit for charging a rechargeable battery with an anode terminal and a cathode terminal, the charging circuit comprising:
a power charger comprising a power converter and a switch circuit; the power converter having a positive output terminal and a negative output terminal, and adapted to convert alternative current (AC) power to direct current (DC) power which is output by the positive output terminal and the negative output terminal; the switch circuit comprising a first input terminal connected to the positive output terminal, a second input terminal connected to the negative output terminal, a first output terminal for connecting to one of the anode terminal and the cathode terminal, and a second output terminal for connecting to the other one of the anode terminal and the cathode terminal.

11. The charging circuit of claim 10, wherein the switch circuit comprises a first group of switches and a second group of switches, one of the first group of switches and the second group of switches is adapted to be switched on for connecting the rechargeable battery to the power converter.

12. The charging circuit of claim 11, wherein the first group of switches is adapted to be switched on when the anode terminal is connected to the first output terminal and the cathode terminal is connected to the second output terminal; and the second group of switches are adapted to be switched on when the cathode terminal is connected to the first output terminal and the anode terminal is connected to the second output terminal.

13. The charging circuit of claim 11, wherein the first group of switches comprises a first transistor and a second transistor, and the first transistor and the second transistor is connected to the power converter.

14. The charging circuit of claim 13, wherein the first transistor comprises a first base terminal, a first collector terminal, and a first emitting terminal, and the second transistor comprises a second base terminal, a second collector terminal, and a second emitting terminal; and the first base terminal is connected to the first output terminal, the first collector terminal is connected to the second output terminal, and the first emitting terminal is connected to the negative output terminal; and the second base terminal is connected to the second output terminal, the second collector terminal is connected to the first output terminal, and the second emitting terminal is connected to the positive output terminal.

15. The charging circuit of claim 14, wherein the first transistor is an NPN-type bipolar transistor, and the second transistor is a PNP-type bipolar transistor.

16. The charging circuit of claim 11, wherein the second group of switches comprises a third transistor and a fourth transistor, and the third transistor and the fourth transistor is connected to the power converter.

17. The charging circuit of claim 16, wherein the third transistor comprises a third base terminal, a third collector terminal, and a third emitting terminal, and the fourth transistor comprises a fourth base terminal, a fourth collector terminal, and a fourth emitting terminal; and the third base terminal is connected to the second output terminal, the third collector terminal is the first output terminal, and the third emitting terminal is connected to the negative output terminal; and the fourth base terminal is connected to the first output terminal, the fourth collector terminal is connected to the second output terminal, and the fourth emitting terminal is connected to the positive output terminal.

18. The charging circuit of claim 17, wherein the third transistor is an NPN-type bipolar transistor, and the fourth transistor is a PNP-type bipolar transistor.

19. The charging circuit of claim 10, wherein the power charger comprises an AC power plug adapted to receive the AC power.
